(19) United States
(12) Patent Application Publication
(10) Pub. No.: US 2011/0030170 A1
(43) Pub. Date: Feb. 10, 2011

(54) Hinge

(76) Inventor: Geoffrey Heaven, Queensland (AU)

Correspondence Address: POLSINELLI SHUGHART PC, 700 W. 47TH STREET, SUITE 1000, KANSAS CITY, MO, 64112-1802, US

(21) Appl. No.: 12/601,996

(22) PCT Filed: May 30, 2008
(86) PCT No.: PCT/AU08/00770

§ 371 Date: Oct. 26, 2010

(30) Foreign Application Priority Data
May 30, 2007 (AU) 2007902888
Feb. 4, 2008 (AU) 2008900497

(51) Int. Cl. E05F 1/12; E05D 5/12; E05D 5/02

(52) U.S. Cl. 16/277; 16/380; 16/387

(57) ABSTRACT

A hinge movable between an extended position and a collapsed position via a hyper-extended position comprising a primary member, a secondary member and a coupling between the members, the coupling movable between a rotating position and a locking position and comprising: a pin connected to the secondary member; a retainer formed in the primary member in which the pin is retained, the primary member being rotatable about the pin and the pin being movable along at least a portion of the length of the retainer; a first arm connected to the primary member for acting against movement of the primary member relative to the pin in a first direction along the length of the retainer; and a second arm connected to the primary member for acting against movement of the primary member relative to the pin in a second direction along the length of the retainer.

### FIELD OF THE INVENTION

The present invention relates to a hinge for moving an element, in particular for moving a bench, shelf or ironing board.

### BACKGROUND OF THE INVENTION

Benches, shelves, ironing boards and the like are often required only for temporary use and at other times may needlessly take up space. This may be a particular issue where the bench, shelf or ironing board has been erected in a small or confined space. In these situations, it is therefore desirable to be able to store the bench, shelf or ironing board when not in use so that it takes up less space.

Various hinge mechanisms for doing so have been previously proposed. However, these hinges often have problems, including that the hinge mechanism is bulky which causes the bench, shelf or ironing board to still protrude significantly, even when in the stored position. Another problem is that these hinges often involve complicated latch or locking mechanisms to hold the hinges in position when the bench, shelf or ironing board is arranged in an in-use position. Not only may these latches or locks be complicated but they may also require a person to get under the bench, shelf or ironing board to unlock the hinge in order to store it away. This may be awkward and/or unsafe as it may cause the bench, shelf or ironing board to come down on top of the person. The latch or lock mechanism may also need to be held in its release position during collapsing of the hinge to store the bench, shelf or ironing board, which may also be awkward or unsafe for the person.

### SUMMARY OF THE INVENTION

According to a first aspect of the present invention, there is provided a hinge movable between an extended position and a collapsed position via a hyper-extended position comprising a primary member, a secondary member and a coupling between the members, the coupling movable between a rotating position and a locking position and comprising:

a pin connected to the secondary member;

a retainer formed in the primary member in which the pin is retained, the primary member being rotatable about the pin and the pin being movable along at least a portion of the length of the retainer;

a first arm connected to the primary member for acting against movement of the primary member relative to the pin in a first direction along the length of the retainer; and
a second arm connected to the primary member for acting against movement of the primary member relative to the pin in a second direction along the length of the retainer.

In an embodiment, the hinge comprises two members being the primary and secondary members.

In an embodiment, one of the members is rotatably connected at one end to a wall and the other member is rotatably connected to an element.

In an embodiment, the hinge comprises four members, two of which are the primary and secondary members.

In an embodiment, each of the four members is rotatably connected to at least two of the other members.

In an embodiment, one of the members other than the primary or secondary members (a first member) is fixed to a wall and the other member which is not the primary or secondary member (a second member) is fixed to an element.

The element may be a bench, shelf or ironing board for example.

In an embodiment, movement of the hinge between the extended position and the collapsed position moves the element between a raised position and a lowered position with respect to the wall.

In an embodiment, when the coupling is in the rotating position, the primary and secondary members are free to rotate relative to one another.

In an embodiment, when the coupling is in the locking position the primary and secondary members are locked against rotation relative to one another.

In an embodiment, when the hinge is in the hyper-extended position, the angle between the primary and secondary members is greater than 90°.

In an embodiment, when the hinge is in the hyper-extended position, the angle between the element and the wall is greater than 90°.

In an embodiment, when the hinge is in the extended position, the angle between the first and second members is approximately 90°.

In an embodiment, when the hinge is in the extended position, the angle between the element and the wall is approximately 90°.

In an embodiment, when the hinge is being moved between the collapsed position and the hyper-extended position, the coupling is in the rotating position.

In an embodiment, when the hinge is being moved between the hyper-extended position and the extended position, the coupling is being moved between the rotating position and the locking position.

In an embodiment, the primary member is substantially U-shaped in cross-section.

In an embodiment, the retainer comprises at least one groove formed in the primary member.

In an embodiment, the retainer comprises opposing grooves formed in the sides of the primary member.

The grooves may or may not be formed through the sides of the primary member.

In an embodiment, the retainer is formed in a first end of the primary member.

In an embodiment, the first end of the primary member is the distal end of the primary member from the element.

In an embodiment, the primary member has a bevel provided at its first end preferably on a side of the primary member which is closest to the element.

In an embodiment, the longitudinal extent of the retainer is angled with respect to the longitudinal extent of the primary member.

In an embodiment, when the hinge is in the extended position, the longitudinal extent of the retainer is closer to horizontal than the longitudinal extent of the primary member.

In an embodiment, the secondary member also comprises a cavity.

In an embodiment, the pin is formed inside the cavity of the secondary member.

In an embodiment, the pin is retained in the retainer by extending between the grooves.

The pin may or may not also extend through the grooves.

In an embodiment, the secondary member is substantially U-shaped in cross-section.

In an embodiment, the cavity extends the length of the secondary member.

In another embodiment, the cavity is formed in a first end of the secondary member.

In an embodiment, the first end of the secondary member is the distal end of the secondary member from the element.

In an embodiment, the movement of the pin relative to the retainer enables the coupling to be moved between the rotating position and the locking position.

In an embodiment, the secondary member also comprises a projection projecting from an inner surface of the cavity.

The inner surface of the secondary member is preferably a surface of an upper portion of the secondary member.

In an embodiment, the projection is located towards the first end of the secondary member.

The first arm generally acts against the coupling being moved out of the locking position.

In an embodiment, the first arm is located inside the primary member.

In an embodiment, the first arm is rotatable relative to the primary member.

In an embodiment, the first arm comprises a pivot portion about which the arm rotates.

In an embodiment, the pivot portion is located within a loop.

In an embodiment, the loop is fixed to the primary member.

In an embodiment, the first arm comprises an abutment portion.

In an embodiment, the abutment portion abuts the projection of the secondary member when the coupling is in the locking position.

In an embodiment, the abutment portion enables the first arm to act against the movement of the pin in the first direction.

In an embodiment, the first arm comprises at least one joining portion for joining the abutment portion to the pivot portion.

In an embodiment, the at least one joining portion project away from the surface of the primary member to which the first arm is connected.

In an embodiment, the first arm comprises a base portion.

In an embodiment, the base portion is connected to the at least one joining portion.

In an embodiment, the base portion rests on the surface of the primary member.

In an embodiment, the base portion positions the at least one joining portion and hence the abutment portion connected thereto where the abutment portion can abut the projection of the secondary member.

In an embodiment, the first arm comprises a foot portion.

In an embodiment, the foot portion is connected to the at least one joining portion.

In an embodiment, when the base portion is resting on the surface of the primary member, the foot portion is raised off the surface.

In an embodiment, the foot portion prevents over-rotation of the first arm when the coupling is moving between the rotating position and locking position.

The second arm generally acts against the coupling being moved out of the rotating position.

In an embodiment, the second arm comprises a resiliently flexible element.

In an embodiment, the resiliently flexible element is connected to a surface of the primary member.

In an embodiment, the second arm comprises a cup portion.

In an embodiment, the cup portion is connected to the resiliently flexible element.

In an embodiment, the cup portion is connected to the distal end of the resiliently flexible element from the surface of the primary member.

In an embodiment, the resiliently flexible element is integrally formed with the loop in which the pivot portion of the first arm is located.

In an embodiment, during rotation of the primary and secondary members relative to one another, the pin is cupped by the cup portion of the second arm.

In an embodiment, the pin abuts an end of the retainer when the coupling is in the rotating position.

In an embodiment, the hinge is operable to move from the hyper-extended position to the extended position (and hence to move the coupling from the rotating position to the locking position) under the application of a downward and inward force on the primary member.

By “inward”, it is understood to mean in a direction towards the wall.

In an embodiment, the force applied to move the hinge from the hyper-extended position to the extended position has to be sufficient to push the cup portion of the second arm out of engagement with the pin.

In an embodiment, application of the force to move the hinge from the hyper-extended to the extended position causes the pin to slide up a side of the cup portion.

In an embodiment, the resiliently flexible element is bent from its initial position as the pin slides up the side of the cup portion.

In an embodiment, the hinge is operable to move from the extended position to the hyper-extended position (and hence to move of the coupling from the locking position to the rotating position) under the application of an upward and outward force on the primary member.

By “outward”, it is understood to mean in a direction away from the wall.

In an embodiment, during movement of the coupling between the rotating position and the locking position the primary member is moved to enable the first arm to clear the projection formed on the secondary member.

In an embodiment, to enable the first arm to clear the projection the primary member is rotated with respect to the secondary member about the pin.

In an embodiment, the angling of the retainer and the bevel provided on the primary member guides rotation of the primary and secondary members during movement of the coupling between the rotating position and the locking position.

In an embodiment, the bevel and the angle of the retainer prevent over-rotation of the primary member during movement of the coupling between the rotating position and the locking position.

In an embodiment, the side of the primary member closest to the element is open at least at the first end of the primary member.

In an embodiment, the opening is provided by the U-shape of the primary member.

In an embodiment, when the coupling is in the locking position the projection is positioned in the primary member.

In an embodiment, when the coupling is in the locking position the abutment portion of the first arm abuts the projection of the secondary member.

In an embodiment, abutment of the abutment portion on the projection acts against the coupling being moved out of the locking position by an upward force on the element.

In an embodiment, when the coupling is in the locking position the length of the primary member which extends past the pin acts against any substantial rotational movement of the primary member about the pin by butting against the inner surface of the secondary member.

In an embodiment, abutment of the primary member against the secondary member when the coupling is in the locking position holds the hinge in the extended position when a downward force is applied on the element.

In an embodiment, the base portion of the first arm provides sufficient weight to cause the first arm to fall back to its initial position once the coupling has been moved out of locking position.

Members, pins, arms and other elements of the hinge may be formed from any suitable material, such as metal for example. They may also be formed of a plastic material, in particular the second arm.

According to a second aspect of the present invention, there is provided a hinge movable between an extended position and a collapsed position, the hinge for moving an element between a lower position and a raised position with respect to a wall and for retaining the element in the element's raised position, the hinge comprising four members, each member rotatably connected to at least two of the other members, wherein two of the members when the hinge is in the extended position form a retaining coupling in which the rotatable connection between the two members is out of alignment with a theoretical line between the two members' other rotatable connections.

The retaining coupling retains the element in its raised position.

Preferably the element's raised position is a storage position for the element and the element's lower position is a working position for the element.

In an embodiment, the hinge is movable from its extended position to its collapsed position by the force of gravity.

In an embodiment, the hinge retains the element in the element's raised position by remaining in the extended position.

In an embodiment, the hinge remains in the extended position by the abutment of the two members which form the retaining coupling.

In an embodiment, the retaining coupling is formed by moving the hinge into its extended position.

The retaining coupling is preferably a loose coupling.

In an embodiment, the hinge is releasable from its extended position by moving the rotatable connection of the two members which form the retaining coupling in a direction which is against the force of gravity.

In an embodiment, the hinge is movable from its collapsed position to its extended position by applying a force to one of the members in a direction which is against the force of gravity. Preferably, the member is not one of the two members which form the retaining coupling.

The element may be a bench, shelf or ironing board, for example.

In an embodiment, the members are arranged to substantially align with one another when the hinge is in the collapsed position.

Hereafter, the four members of the hinge are referred to as first, second, third and fourth members.

In an embodiment, the first member is rotatably connected to the second member, preferably by a first pivot.

In an embodiment, the second member is rotatably connected to the third member, preferably by a second pivot.

In an embodiment, the third member is rotatably connected to the fourth member, preferably by a third pivot.

In an embodiment, the fourth member is rotatably connected to the first member, preferably by a fourth pivot.

In an embodiment, the first, second, third and fourth pivots are each in the form of a pin and slot arrangement. However, the pivots may of any other suitable form.

In an embodiment, the members are arranged to substantially align with one another when the hinge is in the collapsed position by laying parallel to one another.

In another embodiment, the members are arranged to substantially align with one another when the hinge is in the collapsed position by laying flat against one another.

In another embodiment, the members are arranged to substantially align with one another when the hinge is in the collapsed position by three of the members fitting in the other member. This may be referred to as the three members “nesting” in the other member.

In an embodiment, the first, third and second members are arranged to fit in the second member when the hinge is in the collapsed position.

In an embodiment, the third member is arranged to fit in the fourth member when the hinge is in the collapsed position.

In an embodiment, the fourth member is arranged to fit in the first member when the hinge is in the collapsed position.

In an embodiment, the first member is arranged to fit in the second member when the hinge is in the collapsed position.

In an embodiment at least the first, second and fourth members have hollow portions for receiving their respective members when the hinge is in the collapsed position.

In an embodiment, the first, second and fourth members are U-shaped in cross-section.

In an embodiment, the third member is also U-shaped in cross-section. However, in other embodiments the third member may be of another shape such as a rod.

In an embodiment, the first member is fixable to the wall.

The first member is fixable to the wall by any suitable means such as screws, nails, bolts, clips, adhesives for example.

In an embodiment, the second member is fixable to the element.

The second member is fixable to the element by any suitable means such as screws, nails, bolts, clips, adhesives for example.

In embodiment, when the hinge is in the extended position, the second member is at an approximate right angle to the first member so that the element in its raised position extends substantially perpendicularly from the wall.

In an embodiment, the third and fourth members when the hinge is in the extended position form the retaining coupling.

Preferably, the retaining coupling is formed about the third pivot.

In an embodiment, the third pivot is located below a theoretical line between the second and fourth pivots when the hinge is in the extended position.

In an embodiment, the retaining coupling comprises an abutment portion of the fourth member for abutting the third member when the hinge is in the extended position.

In an embodiment, the abutment portion extends past the third pivot.

In an embodiment, the abutment portion loosely overlays the third member.

In an embodiment, the abutment portion comprises a top wall for abutting against the top surface of the third member when the hinge is in the extended position.

In an embodiment, the hinge is releasable from its extended position by moving the third pivot in a direction which is against the force of gravity.

In an embodiment, the hinge is releasable from its extended position by moving the third pivot above the theoretical line between the second and fourth pivots.

In an embodiment, the retaining coupling is formed by applying an upward force to the second member, typically by lifting the element, to cause the second member to rotate about the first pivot.

Preferably, as the hinge reaches its extended position, the third and fourth members drop from alignment with the theoretical line between the second and fourth pivots to below this theoretical line under the force of gravity.

In an embodiment, the hinge also comprises a pivot mount for rotatably connecting the third member to the second member. Thus the pivot mount is for forming the second pivot.

In an embodiment, the pivot mount is located in the second member.

In an embodiment, the pivot mount is located in the hollow portion of the second member.

In an embodiment, the pivot mount enables the third member to be connected to the second member such that when the hinge is in its collapsed position, the third member can be fitted inside the second member.

In an embodiment, the third member is connected to the pivot mount by a pin(s).

The pivot mount may be wider than the third member. In this embodiment, the third member is connected to inner walls of the pivot mount.

In this embodiment, the pivot mount is a U-shaped part.

In other embodiments, the pivot mount is narrower than the third member. In this embodiment, the pivot mount the third member is connected to outer walls of the pivot mount.

In this embodiment, the pivot mount may be a solid block.

In an embodiment, the distance between the third pivot and the end of the pivot mount closest to the third pivot is greater than the distance between the third and fourth pivots.

In another embodiment, the width of the pivot mount is less than the internal width of the fourth member. In this embodiment, the pivot mount fits inside the fourth member when the hinge is in the collapsed position.

According to a third embodiment of the present invention, there is provided a bench which is mountable to a wall, comprising at least one hinge according to the first or second aspect of the present invention.

According to a fourth embodiment of the present invention, there is provided a shelf which is mountable to a wall, comprising at least one hinge according to the first or second aspect of the present invention.

According to a fifth embodiment of the present invention, there is provided an ironing board which is mountable to a wall, comprising at least one hinge according to the first or second aspect of the present invention.

According to a sixth aspect of the present invention, there is provided a hinge movable between an extended position and a collapsed position, the hinge for moving an element between a lower position and a raised position with respect to a wall and for retaining the element in the element's raised position, the hinge comprising two members rotatably connected to one another, one of the members rotatably connected to the element and the other member rotatably connected to the wall, wherein when the hinge is in the extended position, the two members form a retaining coupling whereby the rotatable connection between the two members is out of alignment with a theoretical line between the two members' other rotatable connections.

According to a seventh aspect of the present invention, there is provided a bench which is movable between a lower position and a raised position with respect to a wall, the bench comprising a hinge for moving the bench between its lower and raised positions and for retaining the bench in its raised position.

Preferably, the bench is moved from its lower position to its raised position by application of an upward force.

Preferably the bench's raised position is a working position for the bench and the bench's lower position is a storage position for the bench.

### BRIEF DESCRIPTION OF THE DRAWINGS

Embodiments of the present will now be described, by way of example only, with reference to the accompanying drawings, in which:

FIG. 1 is a side view of a hinge according to an embodiment of the present invention in an extended position;

FIG. 2 is a side view of the hinge of FIG. 1 moving from a collapsed position to the extended position;

FIG. 3 is a side view of an retaining coupling of the hinge of FIG. 1;

FIG. 4 is a cut-away end view of the retaining coupling of FIG. 3 through X-X;

FIG. 5 is an underneath view of the hinge of FIG. 1;

FIG. 6 is a cross-sectional view through Y-Y of FIG. 5;

FIG. 7 is an end view of the rotatable connection between two members of the hinge of FIG. 1;

FIG. 8 is a side view of the rotatable connection between the two members of the hinge through Z-Z of FIG. 7;

FIG. 9A is a schematic view of the hinge of FIG. 1 in use with respect to an ironing board;

FIG. 9B is an illustration of the hinge of FIG. 1 in use with respect to a bench;

FIG. 10 is a side view of a hinge according to another embodiment of the present invention in an extended position;

FIG. 11 is a cross-sectional view of the coupling of the hinge of FIG. 10 through A-A;

FIGS. 12 and 13 are sequential side views of the coupling of the hinge of FIG. 10 as the primary and secondary members rotate with respect to one another;

FIGS. 14 and 15 are sequential side views of the coupling of the hinge of FIG. 10 as the coupling moves from a rotating position to a locking position;

FIG. 16 is a side view of the coupling of the hinge of FIG. 10 in a locking position; and

FIG. 17 is a side view of the coupling of the hinge of FIG. 10 moving out of the locking position towards the rotating position.

### DETAILED DESCRIPTION OF EMBODIMENTS

Referring to the Figures, a hinge 10 movable between an extended position and a collapsed position is shown. The hinge 10 is for moving an element 11, in the form of a bench, shelf, ironing board or the like, between a lower position and a raised position with respect to a wall 12 and for retaining the element 11 in the element's raised position. The element's raised position is a storage position for the element 11 and the element's lower position is a working position for the element 11.

The hinge 10 comprises first, second, third and fourth members 20, 21, 22 and 23 respectively. Each member is rotatably connected to two other members. The first member 20 is rotatably connected to the second member 21 by a first pivot 25. The second member 21 is rotatably connected to the third member 22 by a second pivot 26. The third member 22 is rotatably connected to the fourth member 23 by a third pivot 27. And the fourth member 23 is rotatably connected to the first member 20 by a fourth pivot 28. The pivots 25, 26, 27 and 28 may any suitable pivot arrangement, but in a preferred embodiment the pivots 25, 26, 27, 28 are each in the form of a pin and slot arrangement.

The members are arranged to substantially align with one another by three of the members fitting in the other member when the hinge 10 is in the collapsed position. This advantageously enables the hinge 10 to be collapsed into a very compact shape. As a result, the hinge 10 and thus the element 11 does not protrude significantly from the wall 12 when the hinge 10 is in its collapsed position and the element 11 is in its lowered position. It is noted that in other embodiments, the members may be substantially aligned in other ways, such as by laying parallel to or flat against one another.

Specifically, the first, third and second members 20, 22, 23 are arranged to fit in the second member 21 when the hinge 10 is in the collapsed position. More particularly, the third member 22 is arranged to fit in the fourth member 23 which is arranged to fit in the first member 20 which is arranged to fit in the second member 21 when the hinge 10 is in the collapsed position. Thus, at least the first, second and fourth members 20, 21, 23 have hollow portions for receiving their respective members when the hinge 10 is in the collapsed position. The first, second and fourth members 20, 21, 23 are U-shaped in cross-section. The third member 22 is also preferably U-shaped in cross-section although in other embodiments it may be of another shape such as a rod as it does not require a hollow portion to receive another member when the hinge 10 is in the collapsed position. It should of course be understood that other fitting arrangements of the four members 20, 21, 22, 23 may be possible.

The first member 21 is fixed to the wall 12 by any suitable means (such as screws, nails, bolts, clips, adhesives etc). The second member 22 is similarly fixed to the element 11. It is noted that when the hinge 10 is in the extended position, the second member 22 is at an approximate right angle to the first member 21 so that the element 11 in its raised position extends substantially perpendicularly from the wall 12.

The third and fourth members 22, 23 when the hinge 10 is in the extended position form an retaining coupling 30 in which the rotatable connection between the two members 22, 23 is out of alignment with a theoretical line between the two members' other rotatable connections. The retaining coupling 30 retains the element 11 in its raised position. The retaining coupling 30 is formed about the third pivot 27, whereby the third pivot 27 is located below a theoretical line between the second and fourth pivots 26, 28 when the hinge 10 is in the extended position. The retaining coupling 30 comprises an abutment portion 31 of the fourth member 23 for abutting the third member 22 when the hinge is in the extended position. The abutment portion 31 extends past the third pivot 27 and loosely overlays the third member 22, thus providing a loose retaining coupling 30 as opposed to one which has a tight, friction or interference fit, which enables the abutment portion 31 to freely move into and out of its abutment with the third member 22.

The abutment portion 31 comprises a top wall 32 for abutting against the top surface of the third member 22 when the hinge is in the extended position. Although the abutment portion 31 is shown having side walls 33, in other embodiments, it may not have these.

The retaining coupling 30, in particular the abutment of the abutment portion 31 with the third member 22 acts against the hinge 10 moving out of the extended position by the force of gravity and also by any applied force to the element 11 in the downward direction. This is because with the third pivot 27 below the theoretical line between the second and fourth pivots 26, 28, rotation of the third and fourth members 22, 23 about their respective pivots is prevented by the abutment of the abutment portion 31 with the third member 22.

The hinge 10 may only be released from its extended position by moving the third pivot 27 in a direction which is against the force of gravity so that the third pivot 27 is above the theoretical line between the second and fourth pivots 26, 28. This will enable the rotation of the third and fourth members 22, 23 about their respective pivots 26, 28 and therefore enable the hinge 10 to be moved into its collapsed position and hence move the element 11 from its raised position to its lowered position.

The retaining coupling 30 is formed by moving the hinge 10 into its extended position. This occurs by applying an upward force to the second member 21 (typically by lifting the element 11) to cause it to rotate about the first pivot 25. As the hinge 10 reaches its extended position, the third and fourth members 22, 23 drop from alignment with the theoretical line between the second and fourth pivots 26, 28 to below this theoretical line under the force of gravity. Advantageously, the retaining coupling 30 enables the hinge 10 to remain in its extended position, and therefore for the element 11 to remain in its raised position, even when the element 11 is in use, without the need to lock or otherwise restrain the hinge 10 using any kind of lock or latch mechanism which requires a user to particularly activate. Thus, the problems associated with such lock or latch mechanisms are obviated.

However, in some embodiments (not shown), the hinge could be provided with a lock, latch or other restraining mechanism. Importantly, though, this restraining mechanism would not be required to be held in its release position during movement of the hinge into its collapsed position.

The hinge 10 also comprises a pivot mount 35 for rotatably connecting the third member 22 to the second member 21, ie. for forming the second pivot 26. The pivot mount 35 is located in the second member 21, in particular in the hollow portion of the second member 21. The pivot mount 35 enables the third member 22 to be connected to the second member 21 such that when the hinge 10 is in its collapsed position, the third member 22 can be fitted inside the second member 21. The third member 22 is connected to the pivot mount 35 by a pin or pins 36.

As shown in FIG. 5, the pivot mount 35 may be wider than the third member 22, in which case the third member 22 is connected to inner walls of the pivot mount 35. The pivot mount 35 in the embodiment shown in FIG. 5 is a U-shaped part. However, the pivot mount 35 could be narrower than the third member 22, in which case the pivot mount could be a solid block and the third member would be connected to outer walls of the pivot mount.

It is noted that for the members to fit within each other, in particular for the third member 22 to fit within the fourth member 23, the distance between the third pivot 27 and the end of the pivot mount 35 closest to the third pivot 27 is greater than the distance between the third and fourth pivots 27, 28. This is so there is no interference between the pivot mount 35 and the fourth member 23. In another embodiment, this interference could alternatively be avoided by having the width of the pivot mount 35 less than the internal width of the fourth member 23 so that the pivot mount 35 fits inside the fourth member when the hinge 10 is in the collapsed position.

In another embodiment not shown in the Figures, the hinge may comprise two members rotatably connected to one another. One of the members is rotatably connected to the element and the other member rotatably connected to the wall, wherein when the hinge is in the extended position, the two members form a retaining coupling whereby the rotatable connection between the two members is out of alignment with a theoretical line between the two members' other rotatable connections.

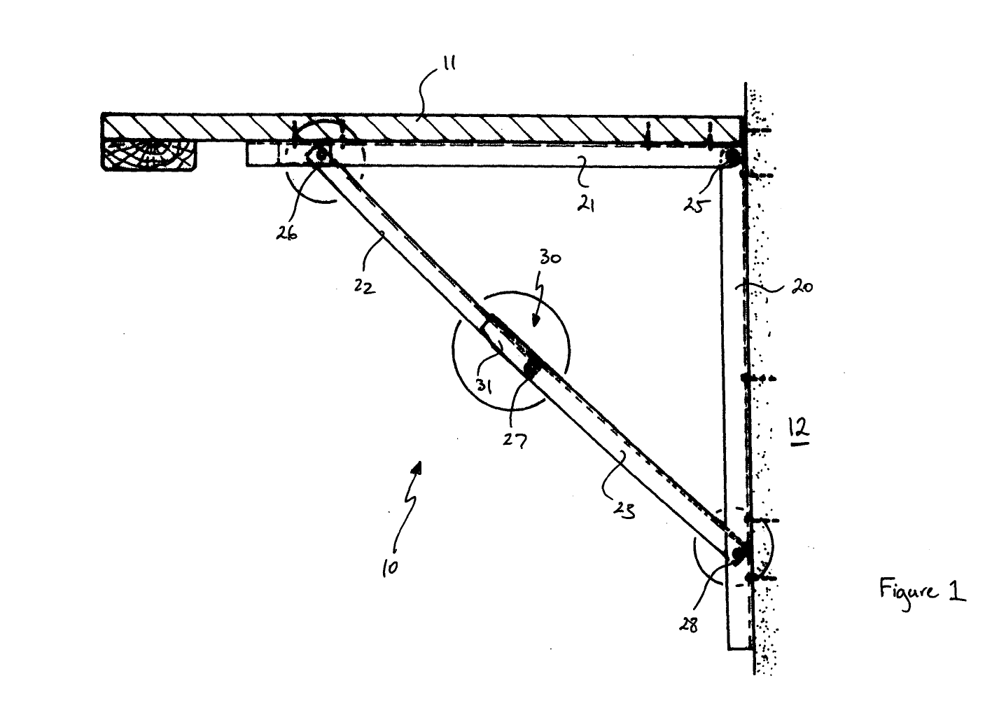

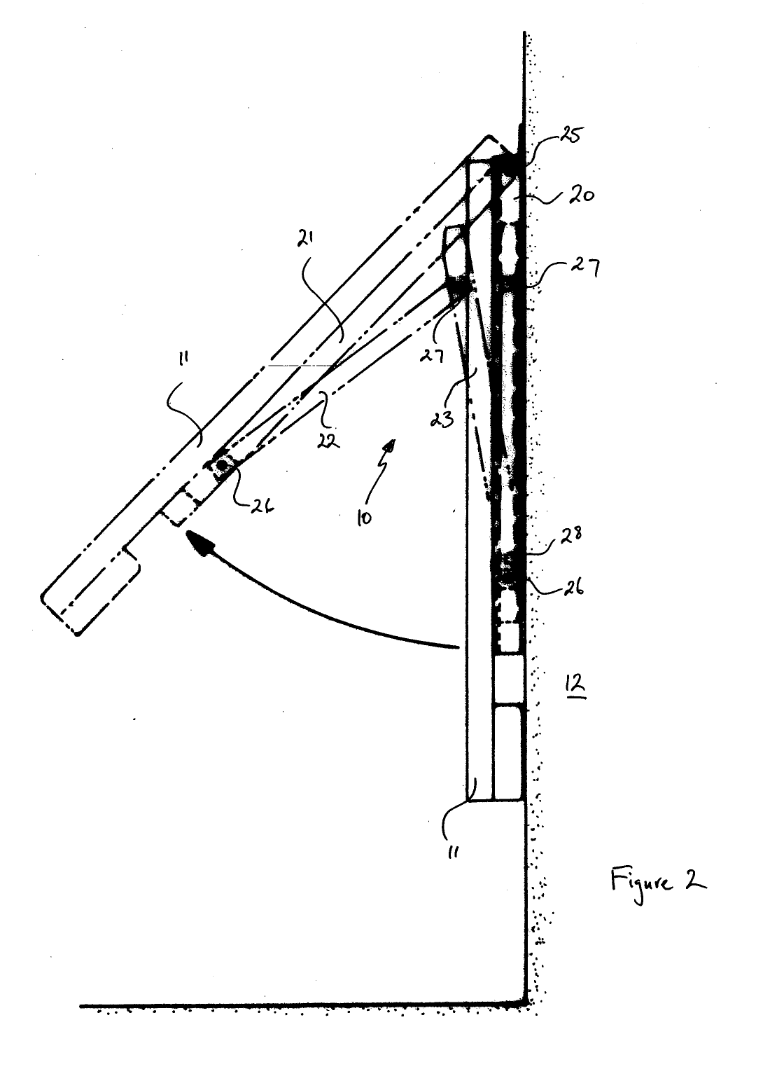

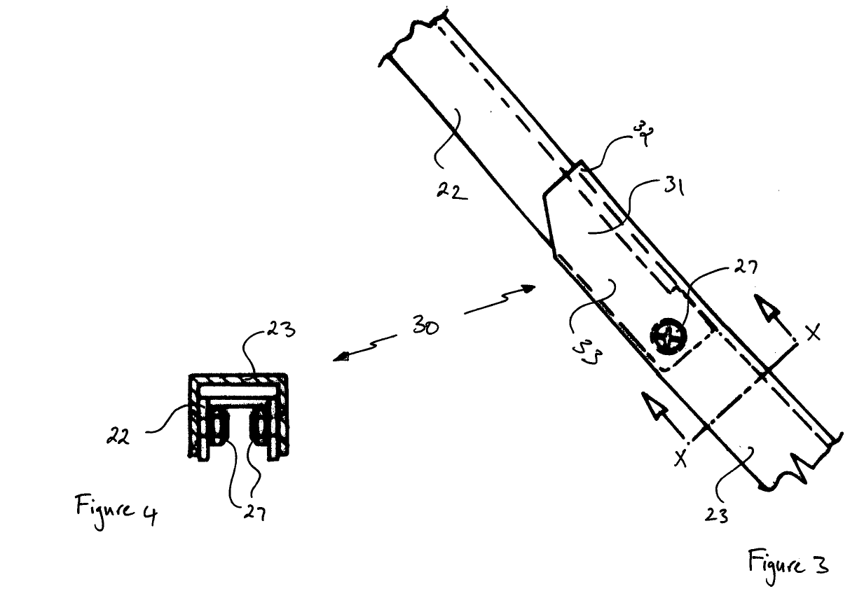

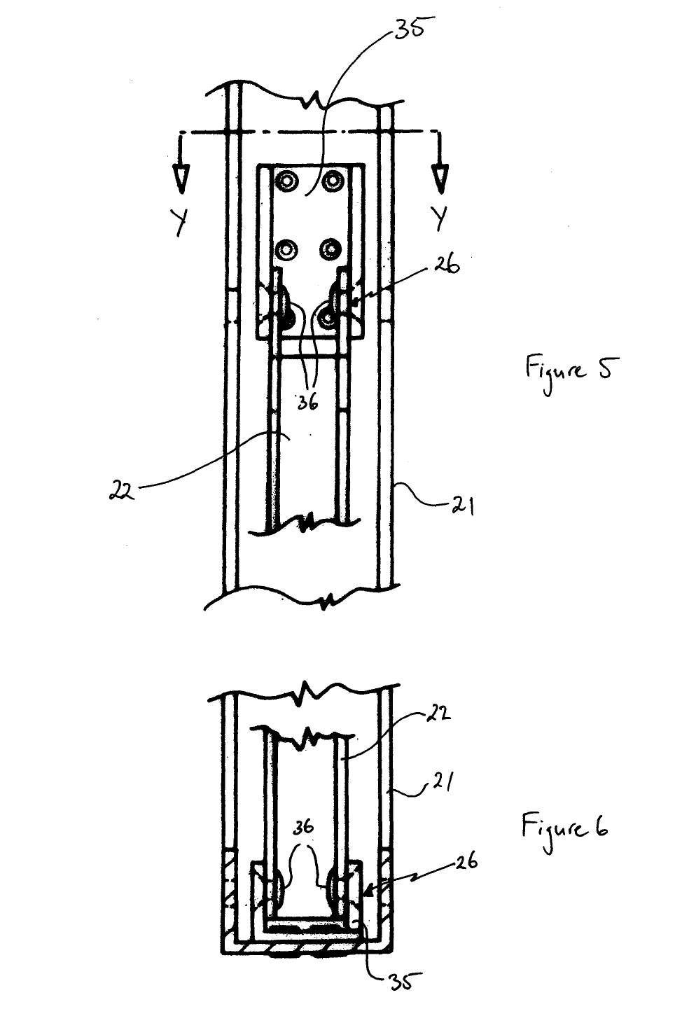

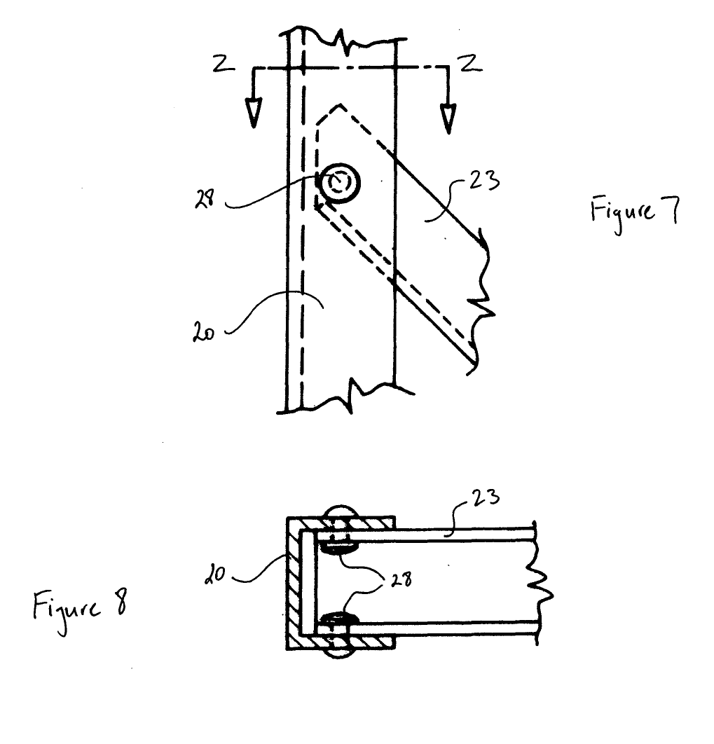

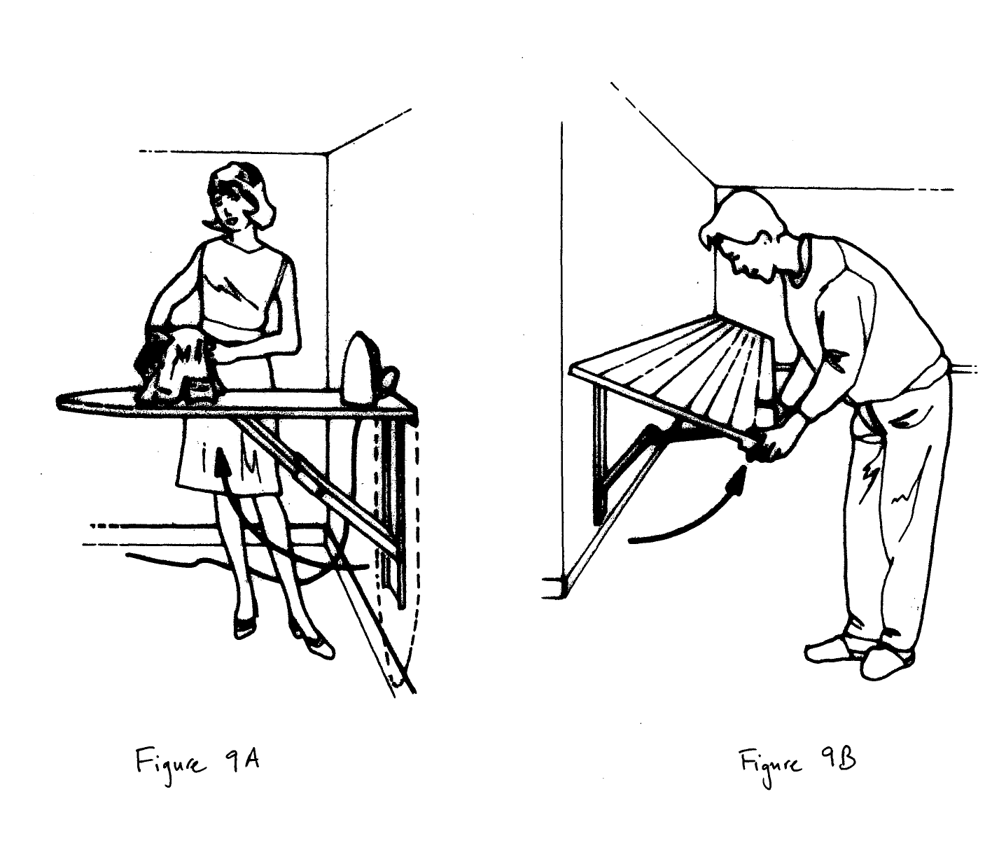

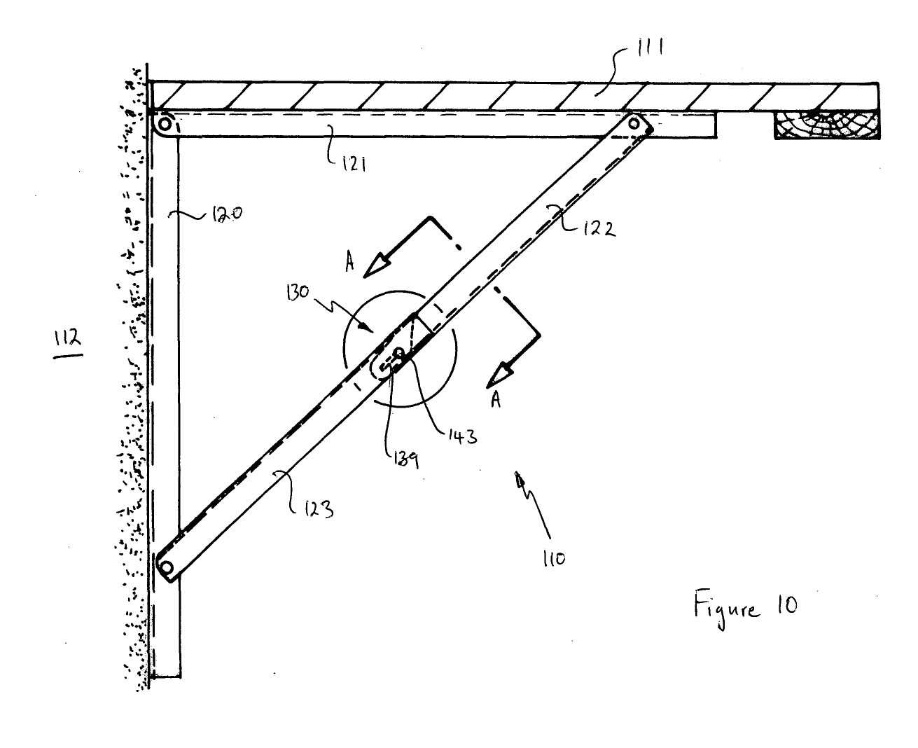

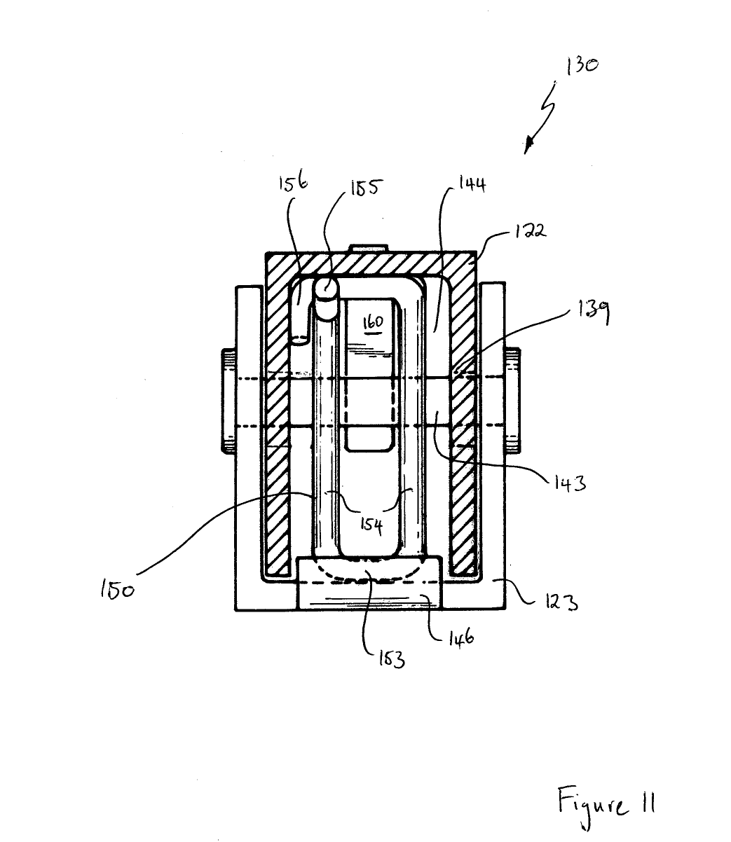

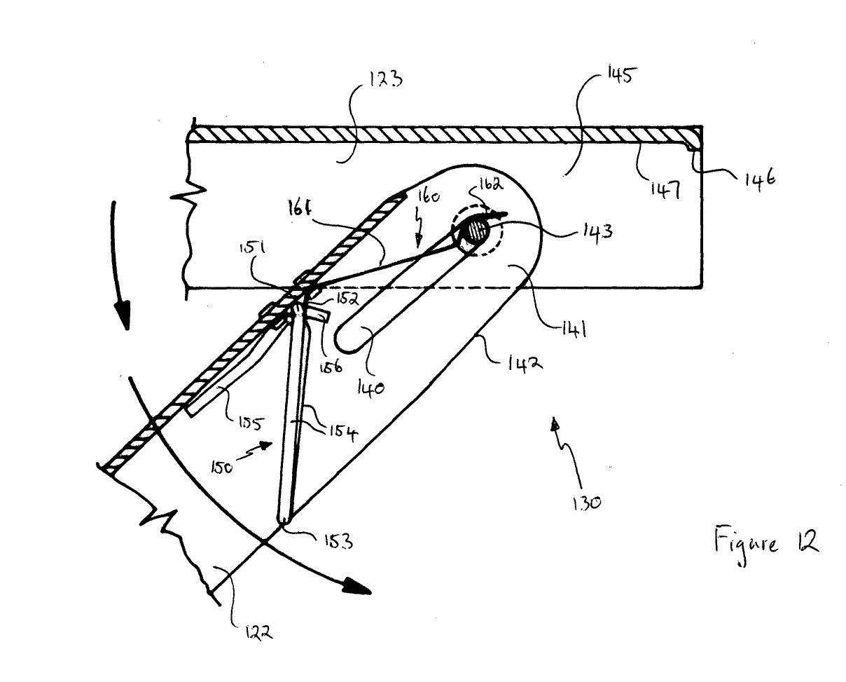

Referring now to FIGS. 10 to 17, a hinge 110 according to another aspect of the present invention is shown. Similar features of the hinge 110 to the hinge 10 shown in FIGS. 1 to 9 have been given the same reference number but have been prefixed with the numeral 1.

The hinge 110 comprises four members 120, 121, 122 and 123 respectively. Third and fourth members 122 and 123 may be referred to as primary and secondary members when describing the hinge 110 of FIGS. 10 to 17. The hinge 110 also comprises a coupling 130 between the primary and secondary members 122, 123. The coupling 130 is movable between a rotating position in which the primary and secondary members 122, 123 are free to rotate relative to one another and a locking position in which the primary and secondary members 122, 123 are locked against rotation relative to one another.

The coupling 130 comprises a retainer 139 formed in the primary member 122 for retaining a pin 143 connected to the secondary member 123 (and described in detail below). The primary member 122 is substantially U-shaped in cross-section, the retainer 139 comprises opposing grooves 140 formed in the sides of the primary member 122. The grooves 140 are shown in the Figures as being formed through the sides of the primary member 122, but in other embodiments they may not be. The retainer 139 is formed in a first end 141 of the primary member 122, being the distal end of the primary member 122 from the element 111. The primary member 122 has a bevel 142 provided at its first end 141 on a side of the primary member 122 which is closest to the element 111. The longitudinal extent of the retainer 139 is angled with respect to the longitudinal extent of the primary member 122. When the hinge 110 is in the extended position, the longitudinal extent of the retainer 139 is closer to horizontal than the longitudinal extent of the primary member 122. The purpose of these features will become apparent further on in the specification.

The coupling 130 also comprises a pin 143 formed inside a cavity 144 of the secondary member 123. The pin 143 is retained in the retainer 139, which in the embodiment shown in the Figures is by extending through and between the grooves 140. In the embodiment shown in the Figures, the secondary member 123 is substantially U-shaped in cross-section and therefore the cavity 144 extends the length of the secondary member 123. However, the secondary member 123 need not be shaped this way and the cavity 144 may be formed in a first end 145 of the secondary member 123, being the distal end of the secondary member 123 from the element 111. The primary member 122 is rotatable about the pin 143 and the pin 143 is movable along at least a portion of the length of the retainer 139. The movement of the pin 143 relative to the retainer 139 enables the coupling 130 to be moved between the rotating position and the locking position.

The secondary member 123 also comprises a projection 146, projecting from an inner surface 147 of the cavity 144, the inner surface 147 being a surface of an upper portion of the secondary member 123. The projection 146 is located towards the first end 145 of the secondary member 123. The purpose of these features will become apparent further on in the specification.

The coupling 130 also comprises a first arm 150 connected to the primary member 122. The first arm 150 acts against movement of the pin 143 along the length of the retainer 139 in a first direction. More specifically, the first arm 150 acts against the coupling 130 being moved out of the locking position. The first arm 150 is located inside the primary member 122 and is rotatable relative to the primary member 122. The first arm 150 comprises a pivot portion 151 about which the arm 150 rotates. The pivot portion 151 is located within a loop 152 which is fixed to the primary member 122.

The first arm 150 also comprises an abutment portion 153. The abutment portion 153 abuts the projection 146 of the secondary member 123 when the coupling 130 is in the locking position. By abutting the projection 146, the abutment portion 153 enables the first arm 150 to act against the movement of the pin 143 in the first direction. A joining portion or portions 154 joins the abutment portion 153 to the pivot portion 151. The joining portion(s) 154 project away from the surface of the primary member 122 to which the first arm 150 is connected.

The first arm 150 also comprises a base portion 155 connected to the joining portions 154. The base portion 155 rests on the surface of the primary member 122, thereby positioning the joining portions 154 and hence the abutment portion 153 connected thereto where the abutment portion 153 can abut the projection 146 of the secondary member 123.

The first arm 150 further comprises a foot portion 156 connected to the joining portions 154. When the base portion 155 is resting on the surface of the primary member 122, the foot portion 156 is raised off the surface. The foot portion 156 is for preventing over-rotation of the first arm 150.

The coupling 130 further comprises a second arm 160 connected to the primary member 122. The second arm 160 acts against movement of the pin 143 along the length of the retainer 139 in a second direction which is opposite to the first direction. More specifically, the second arm 160 acts against the coupling being moved out of the rotating position. The second arm 160 comprises a resiliently flexible element 161 connected to a surface of the primary element 123 and a cup portion 162 connected to the element 161. The cup portion 162 is connected to the distal end of the element 161 from the surface of the primary member 122. In the embodiment shown in the Figures, the element 161 is integrally formed with the loop 152 in which the pivot portion 151 of the first arm 150 is located.

The hinge 110 is movable between an extended position and a collapsed position. In doing so, the hinge 110 moves via a hyper-extended position in which the angle between the first and second members is greater than 90° (and consequently also the element 111 and the wall 112). When the hinge 110 is being moved between the collapsed position and the hyper-extended position, the coupling 130 is in the rotating position, enabling the primary and second members 122, 123 (the third and fourth members) to rotate accordingly. When the hinge is being moved between the hyper-extended position and the extended position (where the first and second members are at an angle of approximately 90°, as are the element 111 and the wall 112), the coupling 130 is being moved between the rotating position and the locking position.

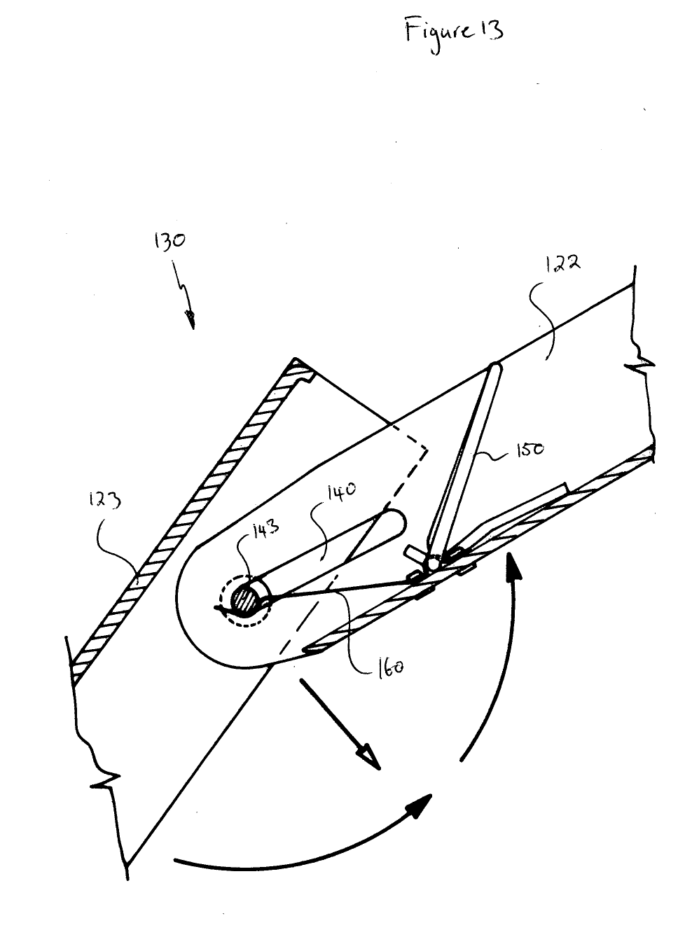

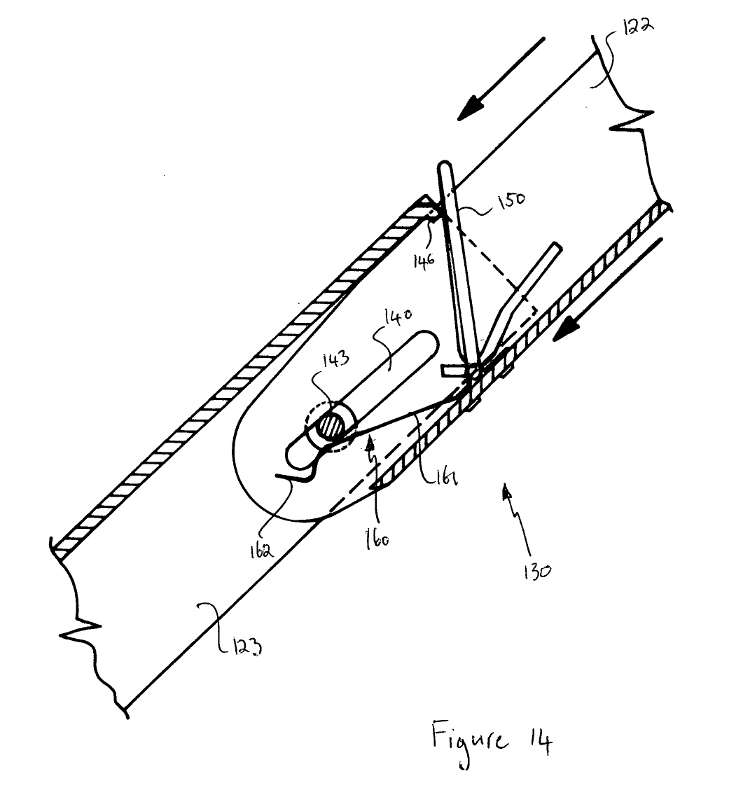

FIGS. 12 and 13 show sequentially the movement of the coupling 130 between the primary and secondary members 122, 123, as the hinge 110 is being moved from the collapsed position to the hyper-extended position. The arrows show the direction of rotation of the primary member 122 relative to the secondary member 123. During this movement, the pin 143 is cupped by the cup portion 162 of the second arm 160. This acts against any movement of the pin 143 along the length of the retainer 139 (in the second direction) because it is difficult for the pin 143 to move past the sides of the cup portion 162. By restricting movement of the pin 143 along the length of the retainer 139 whilst the members 122, 123 are rotating, inadvertent jarring or locking up of the hinge 110 because of such movement of the pin 143 is prevented. Hence, the hinge 110 can move smoothly and easily, with the second arm 160 “controlling” the movement of the pin 143 as the primary and secondary members rotates. In the embodiment shown in FIGS. 12 and 13, the pin 143 also abuts an end of the retainer 139 when the coupling 130 is in the rotating position, although in other embodiments it need not.

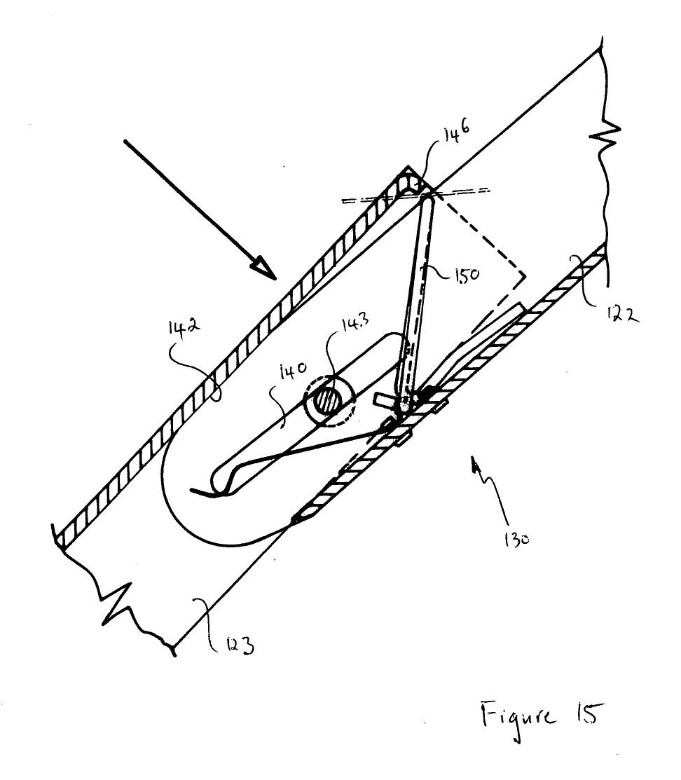

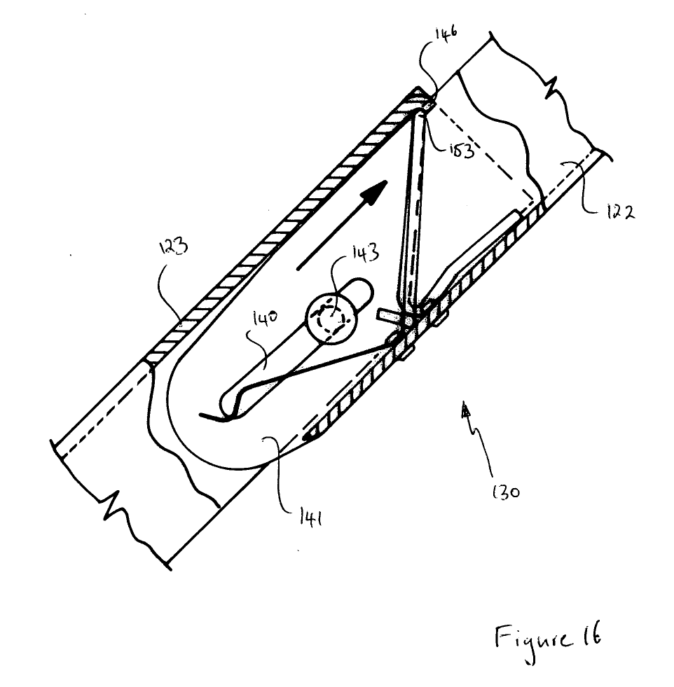

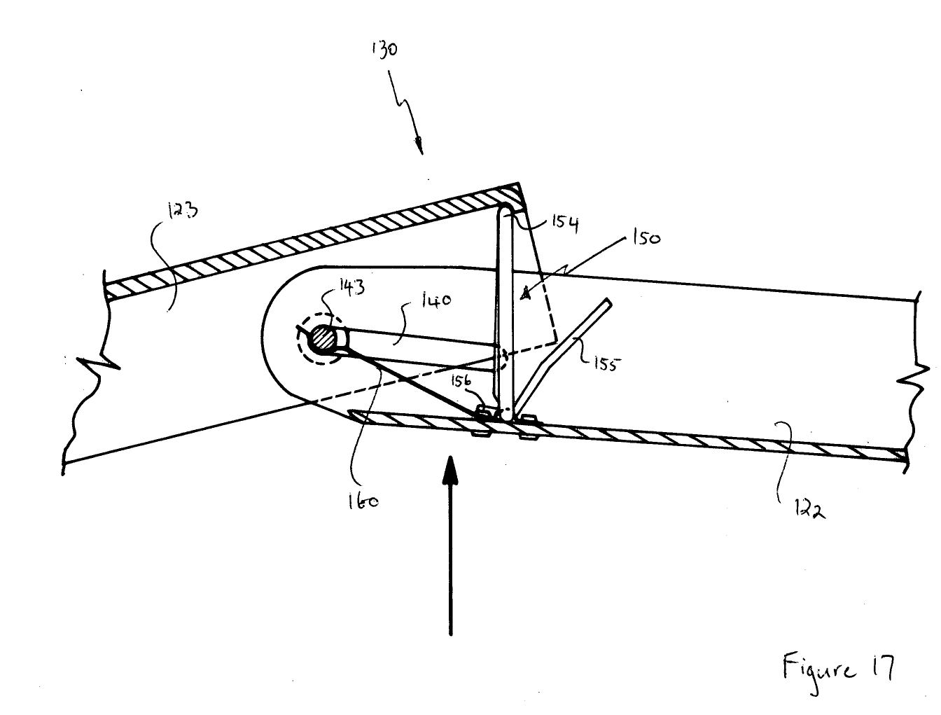

FIGS. 14 and 15 show sequentially the movement of the coupling 130 between the primary and secondary members 122, 123, as the hinge 110 is being moved from the hyper-extended position to the extended position. During this movement, the coupling 130 moves from the rotating position to the locking position as shown in FIG. 16.

To move from the hyper-extended position to the extended position, a downward and inward force is applied to the primary member 122 of the hinge 110. The force applied to the primary member 122 has to be sufficient to push the cup portion 162 of the second arm 160 out of engagement with and past the pin 143. As the force is applied, the pin 143 slides up a side of the cup portion 162. Because the element 163 to which the cup portion 162 is connected is resiliently flexible, as the pin slides up the side of the cup portion 162, the cup portion 162 is pushed down and the element 163 is bent from its initial position (see FIG. 14).

With the pin 143 clear of the second arm 160, the primary member 122 now has to be moved in a way which enables the first arm 150 to clear the projection 146 formed on the secondary member 123 as the primary member 122 is moved into the locking position. As shown in FIG. 15 this involves some slight rotation of the primary member 122 with respect to the secondary member 123 about the pin 143. This rotation is guided by the angling of the retainer 139 and the bevel 142 provided on the primary member 122 as the downward and inward force is continued to be applied to the primary member 122. Importantly, the bevel 142 and retainer 139 prevent any over-rotation of the primary member 122 during this movement phase, thus providing for smooth and easy movement of the coupling 130. Also, the angle of the retainer 139 causes the primary member 122, in particular its first end 141, to be drawn upwards towards the secondary member 123 as the coupling 130 is moved into the locking position.

The side of the primary member 122 closest to the element 111 is open at least at the first end 141 of the primary member 122 so that once the first arm 150 has cleared the projection 146, the primary member 122 can be moved so that the projection 146 of the secondary member 122 is positioned in the primary member 122. In the embodiment shown in the Figures, this opening is provided by the U-shape of the primary member 122. FIG. 16 shows the coupling 130 in the locking position with the projection 146 positioned in the primary member 122. In this position, the abutment portion 153 of the first arm 150 abuts the projection 146 of the secondary member 123. This acts against the coupling 130 being moved out of the locking position by any inadvertent upward force on the element 111 (as indicated by the arrow in FIG. 16), for example if the element 111 was bumped from underneath. In addition, the length of the first end 141 of the primary member 122 which extends past the pin 143 acts against any substantial rotational movement of the primary member 122 about the pin 143 by butting against the inner surface of the secondary portion 123. Thus when a downward force is applied on the element 111, such as when a load is placed on the element 111, the coupling 130 in the locking position holds the hinge 110 in the extended position.

Movement of the coupling 130 out of the locking position and back into the rotating position occurs in reverse of the above described operation, under the application of an upward and outward force on the primary member 123 to move the hinge 110 from the extended position to the hyper-extended position. FIG. 17 shows the movement of the coupling 130 out of the locking position. As shown, some rotation of the primary member 122 relative to the secondary member 123 occurs under application of the upward and outward force and guided by the angling of the retainer 139 and the bevel 142. In order for the first arm 150 to move from abutting the projection 146 some rotation of the first arm 150 occurs. Importantly, the foot portion 156 of the first arm 150 prevents the first arm 150 from over-rotating during movement of the coupling 130 out of the locking position. This stops the first arm 150 getting into a position where it could get trapped and block further movement of the coupling 130. The base portion 155 of the first arm 150 provides sufficient weight to cause the first arm 150 to fall back to its initial position with the base portion 155 resting on the inner surface of the primary member 122 once the coupling 130 has been moved out of locking position.

Members, pins, arms and other elements of the hinge may be formed from any suitable material, such as metal for example. They may also be formed of a plastic material, in particular the second arm.

In the claims which follow and in the preceding description of the invention, except where the context requires otherwise due to express language or necessary implication, the word “comprise” or variations such as “comprises” or “comprising” is used in an inclusive sense, ie. to specify the presence of the stated features but not to preclude the presence or addition of further features in various embodiments of the invention.

1. A hinge movable between an extended position and a collapsed position via a hyper-extended position comprising a primary member, a secondary member and a coupling between the members, the coupling movable between a rotating position and a locking position and comprising:
a pin connected to the secondary member;
a retainer formed in the primary member in which the pin is retained, the primary member being rotatable about the pin and the pin being movable along at least a portion of the length of the retainer;
a first arm connected to the primary member for acting against movement of the primary member relative to the pin in a first direction along the length of the retainer; and
a second arm connected to the primary member for acting against movement of the primary member relative to the pin in a second direction along the length of the retainer.

2. The hinge as claimed in claim 1, wherein the hinge comprises four members, two of which are the primary and secondary members, each of the four members being rotatably connected to at least two of the other members.

3. The hinge as claimed in claim 2, wherein one of the members other than the primary or secondary members is fixed to a wall and the other member which is not the primary or secondary member is fixed to an element.

4. The hinge as claimed in claim 1, wherein the retainer comprises at least one groove formed in the primary member.

5. The hinge as claimed in claim 1, wherein the longitudinal extent of the retainer is angled with respect to the longitudinal extent of the primary member.

6. The hinge as claimed in claim 1, wherein the retainer is formed in a first end of the primary member, the first end of the primary member being provided with a bevel.

7. The hinge as claimed in claim 1, wherein the secondary member comprises a cavity, the pin being formed inside the cavity.

8. The hinge as claimed in claim 1, wherein the retainer comprises opposing grooves formed in the sides of the primary member and the pin is retained in the retainer by extending between the grooves.

9. The hinge as claimed in claim 1, wherein the first arm is rotatable relative to the primary member.

10. The hinge as claimed in claim 1, wherein the first arm is located inside the primary member.

11. The hinge as claimed in claim 1, wherein the first arm comprises an abutment portion for abutting a projection projecting from a surface of the secondary member when the coupling is in the locking position to act against the movement of the pin in the first direction.

12. The hinge as claimed in claim 1, the first arm comprising a base portion which rests on the surface of the primary member when the coupling is in the locking position.

13. The hinge as claimed in claim 1, the first arm comprising a foot portion for preventing over rotation of the first arm when the coupling is moving between the locking position and the rotating position.

14. The hinge as claimed in claim 1, wherein the second arm comprises a resiliently flexible element connected to a surface of the primary member.

15. The hinge as claimed in claim 14, wherein the second arm comprises a cup portion connected to the resilient flexible element, wherein during rotation of the primary and secondary members relative to one another, the pin is cupped by the cup portion of the second arm.

16. The hinge as claimed in claim 15, wherein to move the hinge from the hyper extended position to the extended position, a sufficient force is required to push the cup portion of the second arm out of engagement with the pin.

17. The hinge as claimed in claim 1, wherein when the coupling is in the locking position, the length of the primary member which extends past the pin acts against any substantial rotational movement of the primary member about the pin by abutting against the inner surface of the secondary member.

18. A hinge movable between an extended position and a collapsed position, the hinge for moving an element between a lower position and a raised position with respect to a wall and for retaining the element in the element's raised position, the hinge comprising four members, each member rotatably connected to at least two of the other members, wherein two of the members when the hinge is in the extended position form a retaining coupling in which the rotatable connection between the two members is out of alignment with a theoretical line between the two members other rotatable connections.

19. The hinge as claimed in claim 18, wherein the hinge remains in the extended position by the abutment of the two members which form the retaining coupling.

20. The hinge as claimed in claim 18 wherein the hinge is releasable from its extended position by moving the rotatable connection of the two members which form the retaining coupling in a direction which is against the force of gravity.

21. The hinge as claimed in claim 18, wherein the hinge is movable from its collapsed position to its extended position by applying a force to one of the members in a direction which is against the force of gravity.

22. The hinge as claimed in claim 18, wherein the members are arrange to substantially align with one another when the hinge is in the collapsed position by laying parallel to one another.

23. The hinge as claimed in claim 18, wherein the members are arranged to substantially align with one another when the hinge is in the collapsed position by three of the members fitting in the other member.

24.-27. (canceled)
